(19) United States
(12) Patent Application Publication
(10) Pub. No.: US 2004/0044719 A1
(43) Pub. Date: Mar. 4, 2004

(54) Method and device for the control of multimedia information and communication services

(76) Inventors: Wolfgang Kellerer, Bruck (DE); Peter Moritz, Haar (DE); Peter Sties, Muenchen (DE)

Correspondence Address: MORRISON & FOERSTER LLP, 1650 TYSONS BOULEVARD, SUITE 300, MCLEAN, VA, 22102, US

(21) Appl. No.: 10/380,520

(22) PCT Filed: Sep. 7, 2001
(86) PCT No.: PCT/DE01/03464

(30) Foreign Application Priority Data
Sep. 15, 2000 (DE) 100-45-690.1

(51) Int. Cl. G06F 15/16

(52) U.S. Cl. 709/200

(57) ABSTRACT

The aim of the invention is to produce a network-independent definition and control of services which permits the carrying out of all services on networks connected to the service controller. Said aim is achieved by means of a system, permitting a control of multimedia information and communication services, independent of any aspect of the applied communication network. The service manager unit comprises two basic blocks, the service control unit and the communication control unit. The service manager unit permits the execution of services, requested by a user, by means of various information and communication networks. The networks are selected according to the access for the requested service by a communication control unit. The executing of the service in the service control unit occurs independently of the network selected and the network specific details thereof.

### CLAIM FOR PRIORITY

This application claims priority to International Application No. PCT/DE01/03464 which was published in the German language on Mar. 21, 2002.

### TECHNICAL FIELD OF THE INVENTION

The invention relates to a method for the control of multimedia information and communication services in a communication control unit and a device for the execution of the method.

### BACKGROUND OF THE INVENTION

Information and communications technology is characterized by a large number of transmission standards and transmission systems, on the basis of which a large number of different systems make available services for the subscribers. The subscribers have different terminal devices and different types of network access.

Certain terms should first be defined for the following description:

Service:

Support for the subscriber(s) of communication networks in order to satisfy their communication needs (exchange of information) with locally remote communication points (other subscribers, service provision units) by way of networks which make possible the transport of information

Intelligent Network:

Architecture for central control of additional services in telephony (PSTN, ISDN, GSM) with separate control for call attributes and supplementary service attributes, see ITU Recommendations Q.1200 et seq.

TINA (Telecommunication Information Networking Architecture):

Component-oriented distributed architecture for the future information and communication world, which describes a network, service and management architecture (see TINA Consortium, http://www.tinac.com)

Services are already known in the field of telecommunications, but they have been characterized up until now as being network-specific, such as telephony, TV, e-mail. In this situation, control of the services is conventionally embedded in the transmission control unit.

Previous systems with separate switching control and service control facilities exist only for specific networks, such as intelligent networks for PSTN and PLMN (see above). Control of services is closely linked to functions in network components and contains network-specific details; where applicable also for a plurality of networks. Usage for other transmission networks is not possible.

A multitude of service architectures for specific networks and services are known, such as Intelligent Network, ISDN, ITU H.323 (see J. Toga, J. Ott. ITU-T standardization activities for interactive multimedia communications on packet-based networks) and IETF SIP (H. Schulzrinne, J. Rosenberg. Internet Telephony: architecture and protocols) Internet Telephony. As a result of the constantly increasing diversity of the networks, there is no expectation that a standardized global information and communication infrastructure will become established in the foreseeable future which will replace all systems, as is expected for example from ATM/B-ISDN or of late from the Internet. Rather, it is to be expected that all infrastructures produce common services for the subscribers in order to cover the differing communication requirements and to do justice to the different subscriber connections. While there will continue to be a large number of co-existing networks, in future there will be a far-reaching movement towards convergence on the services level.

The previous approaches aimed at effecting internetwork control of services are shaped from the viewpoint of one network and constitute special solutions, for example PINT (Phone-IP Interworking Services, see http://www.ietf.org/html.charters/pint-charter.html), PARLAY (F.-K. Bruhns. Parlay—the API for Secure and Open Access . . . ), TAPI (Telephone Application Programming Interface), ITU-T H.3xx Family (H.323 for example), IETF IP Telephony (see H. Schulzrinne, J. Rosenberg. Internet Telephony: architecture and protocols). In order to make possible a further reaching decoupling of the service provision level from the transmission network level, many networks already currently offer Application Programming Interfaces (API) which permit external access (third party) for control purposes, for example PARLAY, PINT.

Communication subscribers in competition oriented markets will expect the following in future:

The heterogeneous terminal devices tailored to special requirements should be capable of being used for the greatest possible number of services (for example WAP mobile telephone, palm PC, multimedia PC, TV set, standard telephone)

Differentiation between competitors (service providers) by virtue of: personalized services, high-availability services

New operators (without their own networks) require access and (network-independent) control capabilities: Separation of the service provision level from the transmission network level

The subscriber/end user thus has a desire for constant accessibility both on a personal level (personal mobility) and also constant accessibility of the services (services mobility), and there is also a growing desire for personalized service provision.

It is furthermore the aim of the service providers to reach as many subscribers as possible in the heterogeneous communication field or to offer the subscribers as many alternative ways as possible of using the services already on offer. The subscriber should have the capability, as far as possible, to always have the same services as his disposal from whichever terminal device and transmission network he is currently using.

### SUMMARY OF THE INVENTION

In order to solve the above-identified problem, network-independent definition and control of services are required which enable services to be executed on networks connected to the service controller.

One embodiment of the invention relates to a system which permits control of multimedia information and communication services which is independent of any aspect of the communication networks used. A service manager unit comprises two basic blocks, a service control unit and a communication control unit.

The service manager unit enables services which are requested by a user to be executed by way of various information and communication networks. On the one hand, the user can make his requests to the service manager unit for the user request (service access) from any desired terminal units and through different networks. On the other hand, various networks are brought into use for execution of the service by the service manager unit. The networks are selected according to the access for the requested service by a communication control unit. The execution of the service in the service control unit occurs independently of the network selected and the network-specific details thereof.

Service control remains open in this situation with regard to which network access facilities are used by the subscriber to access services and which networks are available for the control of services (adaptivity) in order to be able to select these networks according to their specific functions, implemented as APIs. In order to guarantee a flexible usage, various networks must be “connectable” and there must be a basic principle of openness with regard to new networks. Already existing services should be able to use newly connected services networks without the need for adaptations or modifications.

Limitations of the existing systems described in the aforementioned:

The Intelligent Network Architecture is specific to telephony. Component oriented structure of service manager units:

for example TINA (Telecommunication Information Networking Architecture): As a result of the subdivision of the system architecture into individual components, independence of the system parts is achieved.

In TINA, the control is nevertheless heavily oriented towards an ATM based switching network. Asynchronous communication is not provided. TINA presupposes intelligent terminal devices with a special infrastructure (middleware). TINA workgroups are concerning themselves in the meantime with the adaptation of TINA for existing networks. In this situation, however, individual solutions are being prepared.

Some approaches (TINA for example) define a general communication platform for the signaling between system components (so-called middleware). This can be used by the system components to exchange messages in accordance with the client/server principle. In this situation, the middleware must be present in the entire infrastructure.

The APIs of the Parlay concept are established in layer 5, but the invention relates to a higher, next level of abstraction than is standardized in the Parlay Consortium.

### BRIEF DESCRIPTION OF THE DRAWINGS

Embodiments of the invention will be described in the following with reference to the drawings. In the drawings:

FIG. 1 shows the system according to the invention.

FIG. 2 shows a first embodiment of an information service.

FIG. 3 shows an extension of the embodiment in FIG. 2.

### DETAILED DESCRIPTION OF THE INVENTION

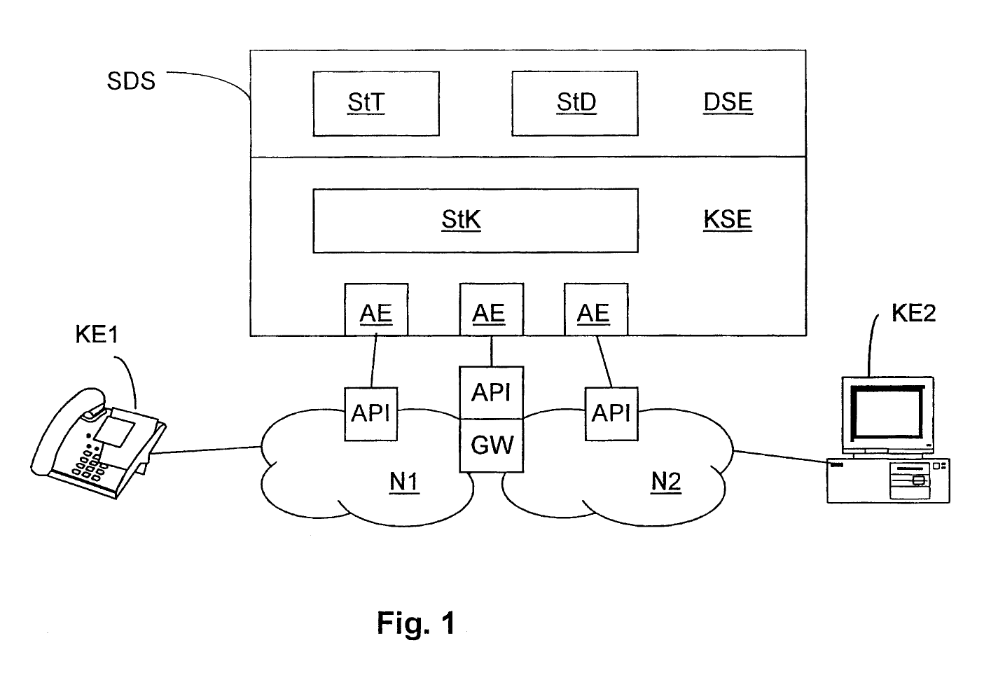

FIG. 1 shows a service control unit (DSE) which includes components (StD) for the network-independent control of information and telecommunication services. The function and sequence control descriptions of the services contained therein are free of information specific to network, subscriber or terminal device. Further components (StT) handle the control of subscriber access and the management of subscriber data. In this situation, management of the subscriber data also includes a knowledge of the capabilities of the terminal devices used (KE2).

The communication control unit block (KSE) includes the components which handle the control of communication sessions required for execution of the service. The control of the communication sessions in the networks (N1, N2) is effected by way of their programming interfaces (API). A coupling of the different networks is achieved on the services level. This means that the existing services for the connected networks are taken into consideration in the service controller described. The networks are not treated as pure transmission networks (for setting up point-to-point connections for example). In certain cases in which no APIs exist or in order to supplement the APIs, the (programming) interface includes the subscriber interface of the network, for example ISDN UNI, TCP/IP (Internet).

The connection to and decoupling from different communication networks is implemented by adapter units (AE). These are based on the different programming interfaces for the networks but at the same time offer a standardized interface. Through this interface, components (StK) within the communication control unit receive information relating to the capabilities of the connected networks and can on the other hand set up and modify communication sessions in these networks and cancel such sessions again. These components then perform a mapping of the communication sessions, which are required for service execution and notified by the service control unit, to the correctly available and useable networks. In this situation, the described communication sessions can also include connectionless data traffic.

In order to make possible internetwork services, network gateways (GW) existing between the networks are also included. In equivalent fashion to the networks, standardized interfaces are formed for the network gateways within the communication control unit by means of adapter units. As a result of the central control of the services by the service control unit, services can then also be defined on an internetwork basis, for example the combination of distribution networks with interactive narrowband networks.

New networks and network gateways can be inserted into the communication control unit at any time by means of appropriately designed adapter units without this necessitating changes or requiring adaptation in the service control unit.

A system for service control in accordance with the above description offers the following advantages:

Simple handling and therefore flexible use in different environments without adaptations.

Rapid expandability to include new networks, porting of existing services to new networks.

Control of services in networks not previously intended for the purpose.

Flexible control of services by way of networks selected on a situation-related basis (adaptivity).

Access to the service control facility by way of access networks independently of the executing network.

Access to the service control facility possible using any desired terminal devices.

Network-independent service control creates independence from service provider and network provider; particularly for smaller providers having no network of their own, complete independence from a special network infrastructure is decisive in terms of the competition.

The system is able to react flexibly to the properties of the communication networks and utilize their functionality for the control of services.

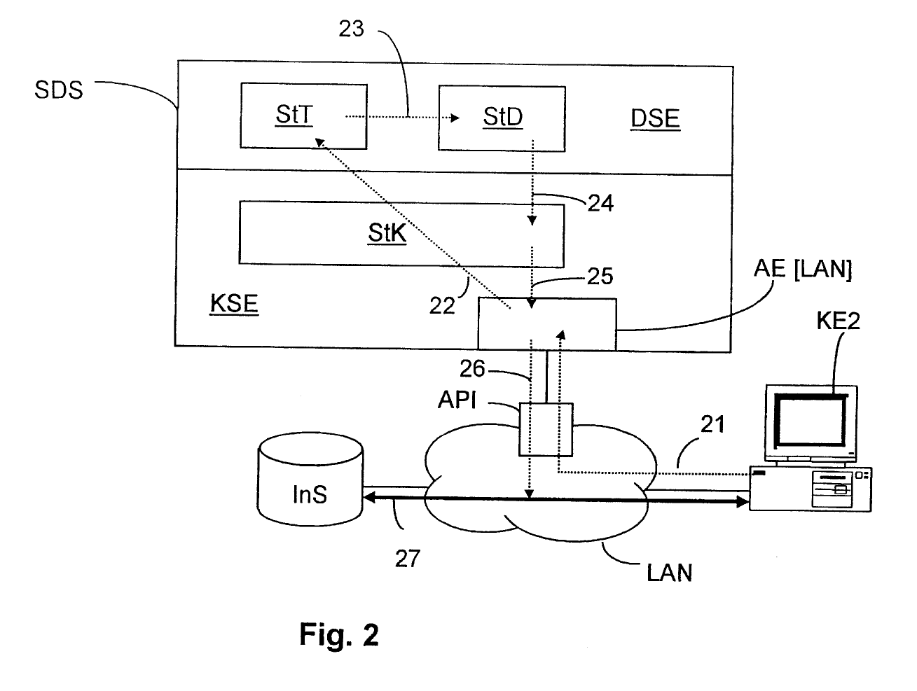

In order to explain how the invention described above functions, an example is illustrated in FIG. 2. In this case, the mode of operation is explained by way of example of an information service (INFO).

A subscriber A has as his terminal device a multimedia PC (KE2) which allows him to display information in the form of hypertext and extensive video sequences. The video sequences can be stopped, fast forwarded and rewound interactively by means of control commands. Let us assume that subscriber A's terminal device is connected by way of a Local Area Network (LAN) to a service control server (SDS) which is functioning in accordance with the methods described in the invention. In order to start the information service, subscriber A uses the terminal device to contact the server SDS by way of the LAN by using the messages of the LAN protocols TCP/IP and HTTP to contact a web server in the adapter unit AE[LAN] of the SDS.

In AE[LAN], the LAN-specific messages are converted into a network-independent message set and forwarded to the components of the service control unit of SDS. There, the components which control subscriber access (StT) take over further processing. After the subscriber A has identified himself by entering a password, for example, the services available to him from his subscriber record are presented to him. At the same time, information about his current access is saved.

After the subscriber has selected the information service INFO, the corresponding processes are started for controlling the service in the components for network-independent control of information and communication services (StD) in the service control unit. In this situation, the subscriber data required for the service is transferred.

The service includes setting up a communication session between the subscriber A and a selected information server (InS) and in controlling the retrieval of information (selection and video control). The InS is similarly located in the LAN. The StD starts the service and transfers to the communication control unit (StK) the message to set up a communication session between subscriber A (terminal TA) and the information server (InS) associated with the service. The communication control unit (StK) fetches from the subscriber record for subscriber A the information about the latter's current access, fetches from a separate database which is not described in more detail information about the information server (InS), and controls the establishment of a communication session between the terminal device and the information server (InS) in the network (LAN) by means of the adapter unit (AP[LAN]). The subscriber can then retrieve information from the information server (InS) by way of his terminal and interactively control the video sequences.

In an embodiment based on the sample scenario described immediately above, the subscriber, who is now travelling away from base, also wishes to access the INFO service with which he is already familiar. The subscriber has a GSM mobile telephone and laptop (KE3) connected to it as a terminal. Since the GSM data link allows an inadequate bandwidth for videos, the laptop additionally contains a unit which permits data reception using digital radio.

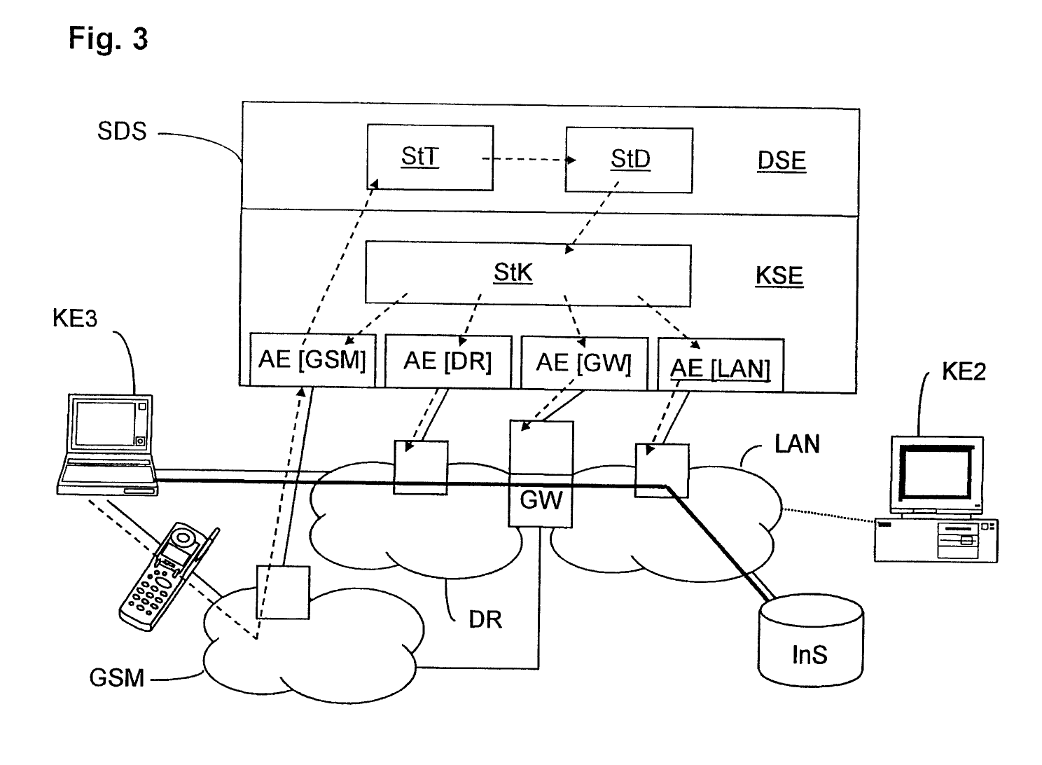

FIG. 3 shows the extension of the sample application. In order to implement this example with the invention described above, two further networks are additionally connected to the server (SDS), a mobile radio network (GSM) and the digital radio (DR). To this end, further suitable adapter units (AE[GSM]) and (AE[DR]) are made available. In order to enable the intercommunication between the different networks, a gateway (GW) must additionally be connected as a network gateway between the LAN and the digital radio. This too is connected to the server—(SDS) by means of a corresponding adapter unit (AE[GW]).

The INFO service and the components in the service control unit (SDS) are not affected by this modification/adaptation. The subscriber A contacts the server SDS by way of a GSM link. In this situation, simply the adapter unit is different in the case of the LAN access (AE[LAN]). The message forwarded by the adapter unit and the execution section in the service control unit (SDS) is identical to the preceding example.

Following an identification process, the subscriber again selects the information service INFO. The service control facility (StD) now instructs the communication control unit (StK) to set up a connection between the terminal of subscriber A (KE3) and the information server (InS).

After a corresponding message has been transferred to the communication control unit (StK) by the service control facility (StD), the communication control unit (StK) fetches information about the current subscriber access and the information server (InS). As a result of the capabilities of the connected networks and the gateway which are known through the adapter units (AE[ ]), the communication control unit (StK) takes the decision to set up the following connections:

In the LAN a link is set up between the information server (InS) and the gateway (GW). From the gateway (GW), a unidirectional link in the direction of the terminal device (KE3) is then set up by way of the digital radio (DR). For the reverse direction, a link is set up from the gateway (GW) by way of the mobile radio network (GSM) to the terminal device (KE3).

The subscriber A can thus use the information service INFO in exactly the same way as in the first example without coming into contact with network-specific details relating to the networks and gateways now used for the transmission.

What is claimed is:

1. (Amended) A method for network-independent control of multimedia information and communication services, comprising:
sending a network-specific message by a service requestor, which is received by a service manager unit;
converting the message by an adapter unit into a network-independent message;
activating, in the service manager unit, by the network-independent message, a function and sequence control facility; and
controlling the set-up of a communication session between the service requestor and the service provider.

2. (Amended) The method according to claim 1, wherein the subscriber access control facility receives the network-independent message and performs a subscriber identification process.

3. (Amended) The method according to claim 1, wherein the subscriber access control facility evaluates the network-independent message, and the available services are offered from subscriber information.

4. (Amended) The method according to claim 3, wherein the subscriber access control facility transfers the subscriber data required for the service to the service control unit.

5. (Amended) The method according to claim 1, wherein the service requestor and service provider are in different networks.

6. (Amended) The method according to claim 1, wherein the communication control unit selects the appropriate link to the requested service based on capabilities, known by the adapter units, of the connected networks.

7. (Amended) A device for network-independent control of multimedia information and communication services, comprising:
at least one service control unit for control of services which is non-specific with regard to network, subscriber and terminal device; and
one communication control unit for controlling the communication sessions in networks.

8. (Amended) The device according to claim 7, wherein the service control unit includes means for function and sequence control and means for control of subscriber access and means for management of subscriber data.

9. (Amended) The device according to claim 7, wherein the communication control unit includes means for control of the communication sessions into the networks, which are required for service execution, and means for mapping the communication session which is required and which is notified by the service control unit onto the network.
